(19) United States
(12) Patent Application Publication
(10) Pub. No.: US 2025/0301372 A1
(43) Pub. Date: Sep. 25, 2025

(54) QUALITY OF SERVICE (QOS) CONTEXT PROPAGATION IN WIRELESS COMMUNICATION SYSTEMS

(71) Applicant: QUALCOMM Incorporated, San Diego, CA (US)

(72) Inventors: Viren UMRIGAR, Dublin, CA (US); Sandip HOMCHAUDHURI, San Jose, CA (US); Gyanranjan HAZARIKA, Milpitas, CA (US); Anuradha CHANDRAMOULI, San Jose, CA (US); Aravind ANBAZHAGAN, San Jose, CA (US)

(21) Appl. No.: 18/888,866

(22) Filed: Sep. 18, 2024

Related U.S. Application Data
(60) Provisional application No. 63/569,483, filed on Mar. 25, 2024.

(51) Int. Cl. H04W 36/00; H04L 41/5009; H04W 36/26

(52) U.S. Cl. CPC H04W 36/0044; H04L 41/5009; H04W 36/26

(57) ABSTRACT

This disclosure provides methods, components, devices, and systems for quality of service (QoS) context propagation in wireless communication systems. Some aspects more specifically relate to a first wireless access point (AP), transmitting to a second wireless AP, a QoS context for a first communication flow established between the first wireless AP and a wireless station (STA). The first wireless AP may transmit the QoS context to the second wireless AP in response to an intent of the wireless STA to roam from a coverage area associated with the first wireless AP to a coverage area associated with the second wireless AP. According to the received QoS context, the second wireless AP may determine various QoS policies of a second communication flow associated with the wireless STA and the second wireless AP and begin communicating with the wireless STA according to the QoS policies after association with the wireless STA.

### CROSS REFERENCE

The present Application for Patent claims priority to U.S. Provisional Patent Application No. 63/569,483 by UMRIGAR et al., entitled “QUALITY OF SERVICE (QOS) CONTEXT PROPAGATION IN WIRELESS COMMUNICATION SYSTEMS” filed Mar. 25, 2024, assigned to the assignee hereof, and expressly incorporated by reference in its entirety herein.

### TECHNICAL FIELD

This disclosure relates generally to wireless communication and, more specifically, to quality of service (QoS) context propagation in wireless communication systems.

### DESCRIPTION OF THE RELATED TECHNOLOGY

Wireless communication networks are widely deployed to provide various types of communication content such as voice, video, packet data, messaging, broadcast, and so on. Some wireless communication networks may be capable of supporting communication with multiple users by sharing the available system resources (such as time, frequency, or power). Further, a wireless communication network may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM), among other examples. Wireless communication devices may communicate in accordance with any one or more of such wireless communication technologies, and may include wireless stations (STAs), wireless access points (APs), user equipment (UEs), network entities, or other wireless nodes.

In some examples, the wireless STA may communicate with a first wireless AP via communication flows that are each associated with a respective quality of service (QoS) context. The respective QoS contexts may include one or more performance metrics for data traffic communicated over the communication flows, such as key performance indicators (KPIs), latency metrics, delay bounds, throughput metrics, or stream classification service (SCS) parameters, among other examples. In examples of associating with (such as accessing with or connecting with) the first wireless AP, the wireless STA and the first wireless AP may negotiate a respective QoS context for each communication flow. Alternatively, in examples in which the wireless STA associates with the first wireless AP, the first wireless AP may analyze the data traffic from the wireless STA (such as inspecting packets received from and/or transmitted to the wireless STA) to establish the respective QoS context for each of the communication flows.

In response to establishing the respective QoS contexts, the first wireless AP may determine one or more respective QoS policies (such as scheduling priorities) for the communication flows. In this way, the first wireless AP may schedule the data traffic for each communication flow according to the one or more respective QoS policies, such that the respective QoS contexts associated with each communication flow are satisfied. In some examples, however, after the wireless STA roams from a first service area associated with the first wireless AP to a second service area associated with a second wireless AP within a same mobility domain (such as a same internet protocol (IP) sub-net)), the QoS contexts for each communication flow for the wireless STA and the first wireless AP may be lost. The second AP may re-establish the respective QoS contexts for each communication flow after association with the wireless STA, which may lead to increased latency, increased signaling overhead, and a decreased efficiency in the communication with the wireless STA, among other challenges.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication by a wireless station (STA) is described. The method may include communicating with a first wireless access point (AP) via a first communication flow according to one or more first quality of service (QoS) policies, the one or more first QoS policies being in accordance with a QoS context established for the first communication flow, transmitting, to the first wireless AP, a first roaming message indicating an intent of the wireless STA to roam from a first service area associated with the first wireless AP to a second service area associated with a second wireless AP, and communicating, in accordance with the first roaming message, with the second wireless AP via a second communication flow according to one or more second QoS policies, the one or more second QoS policies being in accordance with the QoS context established for the first communication flow.

Another innovative aspect of the subject matter described in this disclosure can be implemented in a wireless STA for wireless communication is described. The wireless STA may include a processing system that includes processor circuitry and memory circuitry that stores code. The processing system may be configured to cause the wireless STA to communicate with a first wireless AP via a first communication flow according to one or more first QoS policies, the one or more first QoS policies being in accordance with a QoS context established for the first communication flow, transmit, to the first wireless AP, a first roaming message indicating an intent of the wireless STA to roam from a first service area associated with the first wireless AP to a second service area associated with a second wireless AP, and communicate, in accordance with the first roaming message, with the second wireless AP via a second communication flow according to one or more second QoS policies, the one or more second QoS policies being in accordance with the QoS context established for the first communication flow.

Another innovative aspect of the subject matter described in this disclosure can be implemented in another wireless STA for wireless communication is described. The wireless STA may include means for communicating with a first wireless AP via a first communication flow according to one or more first QoS policies, the one or more first QoS policies being in accordance with a QoS context established for the first communication flow, means for transmitting, to the first wireless AP, a first roaming message indicating an intent of the wireless STA to roam from a first service area associated with the first wireless AP to a second service area associated with a second wireless AP, and means for communicating, in accordance with the first roaming message, with the second wireless AP via a second communication flow according to one or more second QoS policies, the one or more second QoS policies being in accordance with the QoS context established for the first communication flow.

Another innovative aspect of the subject matter described in this disclosure can be implemented in a non-transitory computer-readable medium storing code for wireless communication is described. The code may include instructions executable by one or more processors to communicate with a first wireless AP via a first communication flow according to one or more first QoS policies, the one or more first QoS policies being in accordance with a QoS context established for the first communication flow, transmit, to the first wireless AP, a first roaming message indicating an intent of the wireless STA to roam from a first service area associated with the first wireless AP to a second service area associated with a second wireless AP, and communicate, in accordance with the first roaming message, with the second wireless AP via a second communication flow according to one or more second QoS policies, the one or more second QoS policies being in accordance with the QoS context established for the first communication flow.

Some examples of the method, wireless STAs, and non-transitory computer-readable medium described herein may further include operations, features, means, or instructions for communicating with the second wireless AP via the second communication flow may be in accordance with the second roaming message.

Some examples of the method, wireless STAs, and non-transitory computer-readable medium described herein may further include operations, features, means, or instructions for communicating via the first communication flow may be in accordance with associating with the first wireless AP.

Some examples of the method, wireless STAs, and non-transitory computer-readable medium described herein may further include operations, features, means, or instructions for communicating via the first communication flow may be in accordance with communicating the one or more SCS messages.

In some examples of the method, wireless STAs, and non-transitory computer-readable medium described herein, the QoS context established for the first communication flow may be in accordance with a classification of the first communication flow and the classification of the first communication flow may be based on an artificial intelligence model, a machine learning model, or both.

Another innovative aspect of the subject matter described in this disclosure can be implemented in a method for wireless communication by a first wireless AP is described. The method may include communicating with a wireless STA via a first communication flow according to one or more first QoS policies, the one or more first QoS policies being in accordance with a QoS context established for the first communication flow and transmitting, in accordance with determining that the wireless STA is to roam from a first service area associated with the first wireless AP to a second service area associated with a second wireless AP, control signaling to the second wireless AP indicating the QoS context established for the first communication flow.

Another innovative aspect of the subject matter described in this disclosure can be implemented in a first wireless AP for wireless communication is described. The first wireless AP may include a processing system that includes processor circuitry and memory circuitry that stores code. The processing system may be configured to cause the first wireless AP to communicate with a wireless STA via a first communication flow according to one or more first QoS policies, the one or more first QoS policies being in accordance with a QoS context established for the first communication flow and transmit, in accordance with determining that the wireless STA is to roam from a first service area associated with the first wireless AP to a second service area associated with a second wireless AP, control signaling to the second wireless AP indicating the QoS context established for the first communication flow.

Another innovative aspect of the subject matter described in this disclosure can be implemented in another first wireless AP for wireless communication is described. The first wireless AP may include means for communicating with a wireless STA via a first communication flow according to one or more first QoS policies, the one or more first QoS policies being in accordance with a QoS context established for the first communication flow and means for transmitting, in accordance with determining that the wireless STA is to roam from a first service area associated with the first wireless AP to a second service area associated with a second wireless AP, control signaling to the second wireless AP indicating the QoS context established for the first communication flow.

Another innovative aspect of the subject matter described in this disclosure can be implemented in a non-transitory computer-readable medium storing code for wireless communication is described. The code may include instructions executable by one or more processors to communicate with a wireless STA via a first communication flow according to one or more first QoS policies, the one or more first QoS policies being in accordance with a QoS context established for the first communication flow and transmit, in accordance with determining that the wireless STA is to roam from a first service area associated with the first wireless AP to a second service area associated with a second wireless AP, control signaling to the second wireless AP indicating the QoS context established for the first communication flow.

Some examples of the method, first wireless APs, and non-transitory computer-readable medium described herein may further include operations, features, means, or instructions for communicating via the first communication flow may be in accordance with communicating the one or more SCS messages.

Some examples of the method, first wireless APs, and non-transitory computer-readable medium described herein may further include operations, features, means, or instructions for determining a classification associated with the first communication flow in accordance with one or more data packets communicated over the first communication flow and establishing the QoS context for the first communication flow in accordance with the classification associated with the first communication flow.

Some examples of the method, first wireless APs, and non-transitory computer-readable medium described herein may further include operations, features, means, or instructions for determining the classification associated with the communication flow may be in accordance with one of a machine learning model, an artificial intelligence model, or both.

Another innovative aspect of the subject matter described in this disclosure can be implemented in a method for wireless communication by a first wireless AP is described. The method may include receiving control signaling indicating a QoS context established for a first communication flow associated with a wireless STA and a second wireless AP, applying one or more QoS policies for a second communication flow associated with the wireless STA and the first wireless AP in accordance with the QoS context established for the first communication flow, and communicating with the wireless STA via the second communication flow according to the one or more QoS policies.

Another innovative aspect of the subject matter described in this disclosure can be implemented in a first wireless AP for wireless communication is described. The first wireless AP may include a processing system that includes processor circuitry and memory circuitry that stores code. The processing system may be configured to cause the first wireless AP to receive control signaling indicating a QoS context established for a first communication flow associated with a wireless STA and a second wireless AP, apply one or more QoS policies for a second communication flow associated with the wireless STA and the first wireless AP in accordance with the QoS context established for the first communication flow, and communicate with the wireless STA via the second communication flow according to the one or more QoS policies.

Another innovative aspect of the subject matter described in this disclosure can be implemented in another first wireless AP for wireless communication is described. The first wireless AP may include means for receiving control signaling indicating a QoS context established for a first communication flow associated with a wireless STA and a second wireless AP, means for applying one or more QoS policies for a second communication flow associated with the wireless STA and the first wireless AP in accordance with the QoS context established for the first communication flow, and means for communicating with the wireless STA via the second communication flow according to the one or more QoS policies.

Another innovative aspect of the subject matter described in this disclosure can be implemented in a non-transitory computer-readable medium storing code for wireless communication is described. The code may include instructions executable by one or more processors to receive control signaling indicating a QoS context established for a first communication flow associated with a wireless STA and a second wireless AP, apply one or more QoS policies for a second communication flow associated with the wireless STA and the first wireless AP in accordance with the QoS context established for the first communication flow, and communicate with the wireless STA via the second communication flow according to the one or more QoS policies.

In some examples of the method, first wireless APs, and non-transitory computer-readable medium described herein, the control signaling further indicates a hop count associated with the second communication flow, the hop count being in accordance with a quantity of communication links between the wireless STA and a server.

Some examples of the method, first wireless APs, and non-transitory computer-readable medium described herein may further include operations, features, means, or instructions for applying the one or more QoS policies for the second communication flow may be in accordance with adjusting the one or more parameters of the QoS context.

Some examples of the method, first wireless APs, and non-transitory computer-readable medium described herein may further include operations, features, means, or instructions for adjusting the one or more parameters of the QoS context maintains an end-to-end SLAs associated with the second communication flow.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a process flow that supports quality of service (QoS) context propagation in wireless communication systems.

FIG. 3 shows an example of a signaling diagram that supports QoS context propagation in wireless communication systems.

FIG. 4 shows a block diagram of an example wireless communication device that supports QoS context propagation in wireless communication systems.

FIG. 5 shows a block diagram of an example wireless communication device that supports QoS context propagation in wireless communication systems.

FIG. 6 shows a flowchart illustrating an example process performable by or at a wireless station (STA) that supports QoS context propagation in wireless communication systems.

FIGS. 7 and 8 show flowcharts illustrating example processes performable by or at a first wireless access point (AP) that supports QoS context propagation in wireless communication systems.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Various aspects relate generally to wireless communication and more particularly to propagating quality of service (QoS) contexts during wireless station (STA) mobility. Some aspects relate more specifically to a first wireless access point (AP), transmitting to a second wireless AP, one or more QoS contexts (such as one or more performance metrics) for one or more communication flows established between the first wireless AP and the wireless STA. The first wireless AP may transmit the one or more QoS contexts in response to an intent of the wireless STA to roam from a coverage area associated with the first wireless AP to a coverage area associated with the second wireless AP. In some examples, in response to the wireless STA associating with (such as gaining access to or connecting with) the first wireless AP, the first wireless AP may establish at least a QoS context for a first communication flow at the wireless STA. In such examples, the first wireless AP may communicate with the wireless STA via the first communication flow according to one or more QoS policies (such as scheduling priorities) that have been selected according to the established QoS context. During the communication, the first wireless AP may determine the intent of the wireless STA to roam to the service area associated with second wireless AP. For example, the first wireless AP may receive a first roaming message (such as from the wireless STA) indicating the intent of the wireless STA to roam to the service area associated with the second wireless AP. Additionally, or alternatively, the first wireless AP may determine the intent of the wireless STA to roam into the second service area, and, in response, transmit a second roaming message to the wireless STA indicating for the wireless STA to associate with the second wireless AP. In response to determining the intent of the wireless STA to roam, the first wireless AP may transmit, such as to the second wireless AP, control signaling indicating the QoS context established for the first communication flow. In this way, the second wireless AP may apply one or more QoS policies of a second communication flow associated with the wireless STA and the second wireless AP according to the QoS context established for the first communication flow and communicate with the wireless STA according to the one more QoS policies after association with the wireless STA.

Particular aspects of the subject matter described in this disclosure can be implemented to realize one or more of the following potential advantages. In some examples, by propagating the one or more QoS contexts for each communication flow to the second wireless AP, the described techniques may reduce the latency associated with mobility of a wireless STA roaming between neighboring wireless APs. Further, because the second wireless AP does not re-learn or otherwise re-determine the one or more QoS contexts for each communication flow, the described techniques may be used to reduce signaling overhead between the second wireless AP and the wireless STA, which may lead to a more efficient utilization of resources between the second wireless AP and the wireless STA, among other devices. By a first wireless AP indicating the QoS contexts to the second wireless AP, the second wireless AP may apply one or more QoS policies (such as scheduling priorities) for each communication flow, which may result in the data traffic communicated over the transferred communication flows satisfying the respective QoS contexts. Additionally, by communicating one or more roaming messages between the wireless STA and the first wireless AP, the described techniques may enable the first wireless AP to proactively transmit the one or more QoS contexts to the second wireless AP, leading to better and more efficient coordination between the first wireless AP, the second AP, and/or one or more other wireless APs.

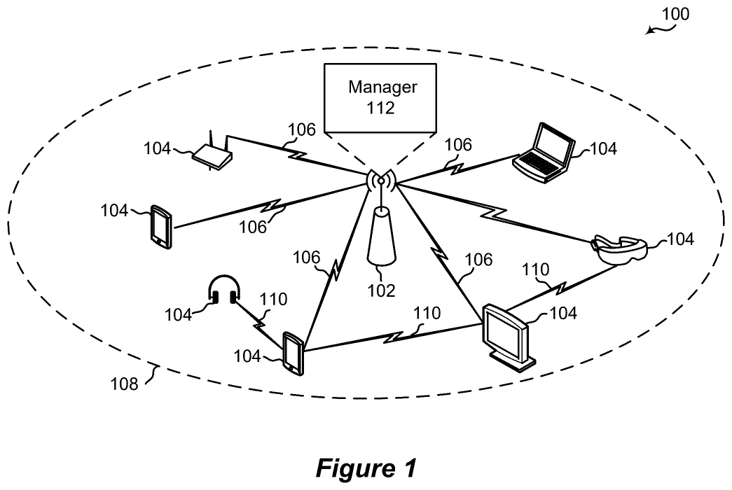

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications, or services.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communication (hereinafter also referred to as “Wi-Fi communication” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communication. For example, the APs 102 or STAs 104, or both, also may be capable of communicating over licensed operating bands. In such examples, multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communication or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some examples, the STA 104 and the AP 102 may communicate via multiple communication flows. A communication flow may be the communication of data packets that are associated with a same application (such as service) operated at the STA 104. For example, the communication flow, which may be referred to as a 5-tuple flow level, may be defined according to a set of parameters that identify a flow of the data packets exchanged between two endpoints, such as the STA 104 and a server associated with the application operated at the STA 104. Such parameters may include a source internet protocol (IP) address (such as the IP address of the device sending the data), a destination IP Address (such as the IP address of the device receiving the data), a source port number (such as the port number at the source device from which the data is being sent), a destination port number (such as the port number at the destination device to which the data is being sent), and/or the communication protocol used for the data transfer (such as transmission control protocol (TCP), user datagram protocol (UDP), among other examples). Such parameters may form an identifier for, or define, a communication flow (such as a flow of data packets having the same parameters and being associated with a same application).

In some examples, the AP 102 may support service defined Wi-Fi (SDWF) and implement a manager 112 (such as a SDWF manager). The AP 102, via the manager 112, may have control over an end-to-end QoS (an end-to-end SLA) of each of the communication flows established with the STA 104. For example, the AP 102, via the manager 112, may use smart traffic classification (such as SDWF service classification), client initiated SCS requests, and/or service level agreement (SLA) administration configurations (such as rules) to establish a QoS context (such as an SLA agreement) for each of the communication flows established with the STA 104. A QoS context may include various performance parameters intended to maintain the end-to-end QoS of data traffic over a communication flow. For example, the QoS context may include key performance indicators (KPIs), latency metrics, delay bounds, a minimum throughput metric, a maximum throughput metric, SCS parameters, among other examples. Each communication flow may have varying QoS contexts according to the type of data traffic communicated over each communication flow (such as voice data, video data, alternate reality (AR) or virtual reality (VR) data, application data, control data, among other examples).

In response to establishing the QoS context for each communication flow, the AP 102, via the manager 112, may perform service queuing and service scheduling according to QoS policies (scheduling prioritization) that have been selected according to the established QoS context for each communication flow. In this way, the AP 102, via the manager 112, may prioritize scheduling data packets associated with communication flows having relatively strict SLAs over scheduling data packets associated with communication flows having relatively relaxed SLAs. As such, the STA 104 and the AP 102 may communicate over the multiple communication flows according to the QoS policies.

In such examples, however, the QoS contexts established by the manager 112 of the AP 102 may be constrained to a domain of a single AP 102, such that the QoS contexts for each communication flow at the STA 104 are not known to other neighboring APs 102. As such, if the STA 104 moves from being associated with the AP 102 to being associated with a second AP 102 (not shown), the learning framework at the second AP 102 may be re-triggered, resulting in inconsistent QoS experiences for the STA 104. That is, if the STA 104 roams from the coverage area 108 (such as a service area) of the AP 102 into a second coverage area 108 (not shown) of the second AP 102, the second AP 102 may re-establish the QoS contexts for each communication flow at the STA 104, resulting in latency and signaling overhead in the communication between the STA 104 and second AP 102.

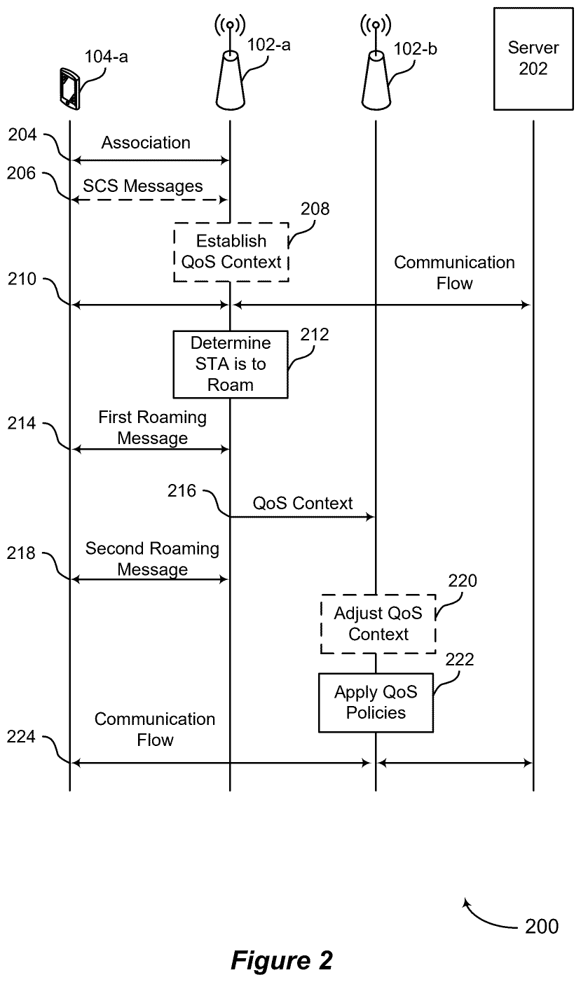

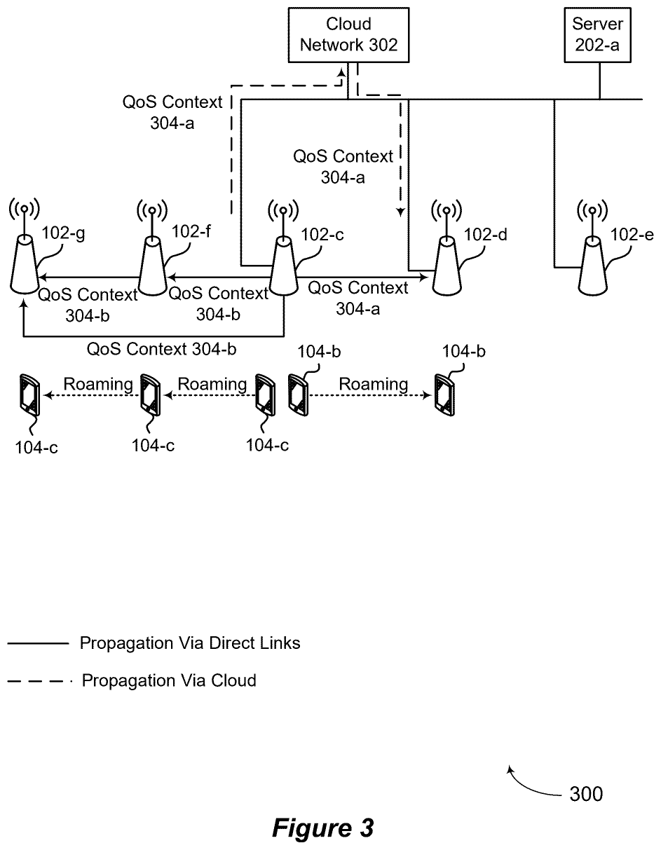

In some implementations, in response to determining that the STA 104 is to roam from the coverage area 108 of the AP 102 to the second coverage area 108 of the second AP 102, the AP 102 may transmit, to the second AP 102, control signaling indicating each QoS context established for the communication flows associated with the STA 104. In this way, the second AP 102 may apply QoS policies according to the indicated QoS contexts and begin communicating with the STA 104 via the multiple communication flows according to the applied QoS policies. Such techniques for QoS context propagation may be further described herein with reference to FIGS. 2 and 3.

FIG. 2 shows an example of a process flow 200 that supports QoS context propagation in wireless communication systems. Aspects of the process flow 200 may be implemented by the wireless communication network 100. For example, the process flow may include a STA 104-a, which may be an example of a STA 104 as described with reference to FIG. 1. Additionally, the process flow 200 may include an AP 102-a (such as a first wireless AP) and an AP 102-b (such as a second wireless AP), which may be examples of the AP 102 as described with reference to FIG. 1. The process flow 200 also may include a server 202 that is associated with an application operated at the STA 104-a. The techniques described in the context of the process flow 200 may enable the AP 102-a to indicate, to the AP 102-b, a QoS context associated with a communication flow established between the STA 104-a and the AP 102-a in response to the STA 104-a roaming to a service area of the AP 102-b.

At 204, the STA 104-a may associate with the AP 102-a (such as the first wireless AP). For example, the STA 104-a may operate within a service area of the AP 102-a and connect to the AP 102-a.

In some examples, at 206, the STA 104-a and the AP 102-a may communicate SCS messages to establish a QoS context for a communication flow between the STA 104-a and the server 202. That is, the AP 102-a and the STA 104-a may negotiate the QoS context for the communication flow via the SCS messages. For example, the AP 102-a may utilize the information provided by the STA 104-a via the SCS messages to establish the QoS context associated with the communication flow.

In some other examples, at 208, the AP 102-a may establish the QoS context for the communication flow according to SLA administration configurations, traffic classification analysis, or both. For example, the AP 102-a may utilize administrator programmed SLA configurations to establish the QoS context for the communication flow. In such examples, the AP 102-a may be programmed (by an administrator of the network) with multiple SLA configurations that each define a respective QoS context. As such, the AP 102-a may select one of the QoS context, according to the SLA administration configurations, and associate the selected QoS context with the communication flow.

Alternatively, the AP 102-a may utilize traffic classification services (such as centralized traffic classification) to classify and associate (such as establish) the communication flow with the QoS context. In such examples, the AP 102-a may inspect initial data packets communicated over the communication flow to classify the flow as an SLA flow (such as a QoS supported flow) or a non-SLA flow (such as non-QoS supported flow). For example, the AP 102-a may utilize one or more packet inspection algorithms, such as deep packet inspection algorithms, to determine the classification type of the data packets. In some examples, the AP 102-a may utilize machine learning (ML) models, artificial intelligence (AI) models, or both to determine the classification of the communication flow.

For example, the STA 104-a may communicate an initial data packet over the communication flow. The AP 102-a may analyze the initial data packet, using ML models, AI models, among other examples, to determine the classification of the initial data packet (such as whether the initial data packet is a voice data packet, video data packet, AR or VR data packet, control data packet, among other examples). In response to determining the classification of the initial data packet, the AP 102-a may have an indication of the classification for the communication flow and establish the QoS context according to the classification. In such examples, at 206 and 208, the AP 102-a may detect the communication flow, such as by communicating one or more data packets with the STA 104-a and establish the QoS context for the communication flow.

At 210, the STA 104-a and the AP 102-a may communicate via the communication flow according to a first set of QoS policies that are selected according to the QoS context established for the communication flow. For example, the AP 102-a may apply (such as enforce) the first set of QoS policies for data packets communicated over the communication flow, such that the data packets satisfy the SLAs established for the communication flow. The first set of QoS policies may indicate a scheduling priority of the communication flow.

For example, in accordance with the first set of QoS policies, the AP 102-a may program, using hardware or software, priority queues for the communication flow and utilize the manager 112 (such as an SDWF scheduler) to prioritize the data traffic associated with the communication flow, such that the data traffic satisfies the QoS context. As an illustrative example, the AP 102-a may prioritize scheduling data packets associated with communication flows having relatively strict SLAs over data packets associated with communication flows having relatively relaxed SLAs according to the QoS policies.

The data packets communicated over the communication flow may be associated with an application operated on the STA 104-a, in which the application may be associated with the server 202. As such, in uplink communication over the communication flow, the STA 104-a may transmit data packets associated with the application to the AP 102-a, such that the AP 102-a may forward the data packets to the server 202. Similarly, in downlink communication over the communication flow, the server 202 may transmit data packets associated with the application at the STA 104-a to the AP 102-a, such that the AP 102-a may forward the data packets to the STA 104-a. As such, the AP 102-a may control the end-to-end QoS of the data packets communicated over the communication flow by scheduling the time and frequency resources at which the data packets are received from, and transmitted to, the STA 104-a according to the QoS policies.

In some examples, however, if the STA 104-a roams to another access point, such as the AP 102-b, within a same mobility domain (such as within a same internet protocol (IP) sub-network), the QoS context established for the communication flow may be lost. As such, in response to the STA 104-a associating with the AP 102-b, the AP 102-b may re-establish the QoS context for the communication flow, which may include re-learning of the established flows, re-establishing SCS, performance of the traffic classification services with the STA 104-a, reprogramming QoS queues post re-association, among other examples. That is, the AP 102-b may perform the operations at 206 and 208 with the STA 104-a to obtain the QoS context for the communication flow, which may add latencies, increase signaling overhead, and/or may breach the QoS context for the communication flow at the STA 104-a during mobility to the AP 102-b.

In accordance with the techniques described herein, the AP 102-a may indicate the QoS context for the first communication flow to the AP 102-a in response to the STA 104-a roaming from a service area associated with the AP 102-a to the service area associated with the AP 102-b.

For example, at 212, the AP 102-a may determine that the STA 104-a is to roam from the service area (such as first coverage area) associated with the AP 102-a to the service area (such as a second coverage area) associated with the AP 102-b. In some examples, the AP 102-a may determine that the STA 104-a is to roam according to an analysis of signals communicated between the AP 102-a and the STA 104-a. For example, the AP 102-a may measure the signal strength and/or signal-to-noise ratio (SNR) of signals received from the STA 104-a and determine, in accordance with the measured signal strength and/or SNR whether the STA 104-a is roaming away from the service area associated with the AP 102-a and into the service area of the AP 102-b (such as a neighboring AP 102).

Additionally, or alternatively, the AP 102-a may perform a load balancing procedure to reduce the quantity of STAs 104 associated with the AP 102-a, and, as such, transmit to the STA 104-a the first roaming message indicating for the STA 104-a to associate with the AP 102-b at 214. That is, at 214, the AP 102-a may transmit, via the first roaming message and in accordance with performing the load balancing procedure, an indication for the STA 104-a to roam from the service area associated with the AP 102-a to the service area associated with the AP 102-b. In some other examples, at 212, the AP 102-a may determine a quantity of failures in satisfying the SLAs of the communication flow between the STA 104-a and the server 202. That is, at 212, the AP 102-a may identify a quantity of breaches in the SLAs associated with the communication flow during communication with the STA 104-a and the server 202. As such, if the quantity of failures satisfies a threshold, the AP 102-a may transmit the first roaming message indicating for the STA 104-a to rom to the service area associated with the AP 102-b at 214.

In some other examples, at 214, the STA 104-a may indicate an intent of the STA 104-a to roam according to communication of a first roaming message (such as a roaming indication). For example, the AP 102-a may receive, from the STA 104-a, the first roaming message that indicates the intent of the STA 104-a to roam into the service area of the AP 102-b. In such examples, the STA 104-a may include, in the first roaming message, an identifier (ID) of the AP 102-b, such that the AP 102-a has an indication of which AP 102 to indicate the QoS context in the operations at 216. In some examples, in response to determining that the STA 104-a is to roam at 212, the AP 102-a may transmit the first roaming message to the STA 104-a, such that the STA 104-a may begin mobility and associate with the AP 102-b. In such examples, the AP 102-a may indicate, via the first roaming message, the ID of the AP 102-b, among other information, such that the STA 104-a may begin to associate with the AP 102-b.

At 216, in response to determining that the STA 104-a is to roam at 212 and/or receiving the first roaming message at 214 indicating the intent of the STA 104-a, the AP 102-a may transmit control signaling indicating the QoS context established for the communication flow to the AP 102-b. For example, the AP 102-a may indicate the KPIs associated with the communication flow, the latency metrics associated with the communication flow, the delay bounds associated with the communication flow, the throughput metrics associated with the communication flow, the SCS parameters associated with the communication flow, among other examples, to the AP 102-b.

In some examples, the AP 102-a may transmit the control signaling indicating the QoS context to the AP 102-b via direct signaling, using a backhaul Wi-Fi connection and/or a backhaul ethernet connection. In some other examples, the AP 102-a may transmit the control signaling indicating the QoS context to the AP 102-b via a cloud associated with both the AP 102-a and the AP 102-b. Such techniques may be further described with reference to FIG. 3. In some other examples, the AP 102-a may broadcast the QoS context established for the communication flow to multiple neighboring APs 102 that are within the same mobility domain, such neighboring APs 102 may include the AP 102-b.

In some examples, if the AP 102-a and the AP 102-b operate within a mesh network, in which the AP 102-a is in communication with the server 202 and the AP 102-b communicates with the server 202 via the AP 102-a, the AP 102-a may indicate a hop count associated with communication of data traffic over the communication flow via the AP 102-a. The hop count may be equal to the quantity of communication links established for communication of data traffic between the AP 102-a, such as the AP 102 serving the STA 104-a, and the server 202. As such, according to the hop count, the AP 102-b may have an indication of the quantity of communication links between the STA 104-a and the server 202.

As an illustrative example, if the STA 104-a communicates with the server 202 via the AP 102-a, the hop count may be equal to one, in which a communication link between the AP 102-a and the server 202 is a single hop. The communication link between the STA 104-a (such as the client) and the AP 102-a may not count as a hop. As another illustrative example, if the STA 104-a communicates with the server 202 via both the AP 102-a and the AP 102-b, the hop count may be equal to two, in which a communication link between the AP 102-b and the AP 102-a is a first hop and the communication link between the AP 102-a and the server 202 is a second hop. Such techniques to indicate the hop count may be further described herein with reference to FIG. 3.

At 218, in response to, or in conjunction with, transmitting the QoS context to the AP 102-b, the AP 102-a and the STA 104-a may communicate a second roaming message indicating an acknowledgement of the intent of the STA 104-a to roam into the service area of the AP 102-b. For example, if, at 214, the STA 104-a transmits the first roaming message, the AP 102-a may transmit the second roaming message indicating the acknowledgement of the intent of the STA 104-a to roam. In such examples, in response to receiving the second roaming message, the STA 104-a may associate (such as access or connect to) the AP 102-b.

Alternatively, if, at 214, the AP 102-a transmits the first roaming message, the STA 104-a may transmit the second roaming message indicating the acknowledgement of the intent of the STA 104-a to roam. In such examples, in response to transmitting the second roaming message, the STA 104-a may associate (such as access or connect to) the AP 102-b. Prior to the STA 104-a associating with the AP 102-b, the AP 102-b may transmit the QoS context to the AP 102-b.

In some examples, at 220, if the AP 102-a and the AP 102-b operate within the mesh network, the AP 102-b may determine a hop count (such as a quantity of communication links between the STA 104-a and the server 202), and adjust the QoS context according to the hop count. For example, the AP 102-b may receive an indication of the hop count from the AP 102-a, in which the indication of the hop count may be from the perspective of the AP 102-a (such as indicate the quantity of communication links between the STA 104-a and the server 202 with the AP 102-a serving the STA 104-a). Accordingly, the AP 102-b may adjust the hop count to be from the perspective of the AP 102-b, such that the AP 102-b may have an indication of the quantity of communication links between the STA 104-a and the server 202 with the AP 102-b serving the STA 104-a. In response to adjusting the hop count, the AP 102-b may adjust the QoS context of the communication flow according to the hop count, such that the AP 102-b may maintain an end-to-end QoS (such as end-to-end SLA) for the communication flow. Techniques to adjust the QoS context may be further described with reference to FIG. 3.

At 222, in response to receiving the QoS context, the AP 102-b may select and apply a second set of QoS policies for the communication flow according to the QoS context established by the AP 102-a for the communication flow. For example, because the AP 102-b receives the QoS context for the communication flow associated with the STA 104-a, the AP 102-b may refrain from performing the operations at 206 and at 208, and instead determine and apply the second set of QoS policies for the communication flow according to the received QoS context, which may reduce latency and signaling overhead during communication with the STA 104-a. That is, the AP 102-b may avoid re-learning and re-establishing the QoS context associated with the communication flow at the STA 104-a in response to receiving the QoS context from the AP 102-a. As such, the AP 102-b may apply the QoS policies according to the received QoS context for the communication flow, which may reduce latency in the communications between the STA 104-a and the AP 102-b.

At 224, the STA 104-a may communicate with the AP 102-b via the communication flow according to the second set of QoS policies. For example, in response to the STA 104-a associating with the AP 102-b and transferring the communication flow from the AP 102-a to the AP 102-b, the STA 104-a and the AP 102-b may communicate via the communication flow according to the second set of QoS policies applied at 220.

FIG. 3 shows an example of a signaling diagram 300 that supports QoS context propagation in wireless communication systems. Aspects of the signaling diagram 300 may implement, or be implemented by, aspects of the wireless communication network 100 and the process flow 200 as described with reference to FIGS. 1 and 2. For example, the signaling diagram 300 may include a STA 104-b and a STA 104-c, which may be examples of a STA 104 as described with reference to FIGS. 1 and 2. The signaling diagram 300 also may include an AP 102-c (such as a first wireless AP), an AP 102-d, an AP 102-e, an AP 102-f, and an AP 102-c, which may be examples of the APs 102 described with reference to FIGS. 1 and 2. Further, the signaling diagram 300 may include a server 202-a, which may be an example of the server 202 as described with reference to FIG. 2, and include a cloud network 302. The techniques described in the context of the signaling diagram 300 may enable the AP 102-c to propagate QoS contexts 304 to one or more APs 102 in response to the STA 104-b and/or the STA 104-c roaming into coverage areas of the one or more neighboring APs 102.

In some examples, the AP 102-c, the AP 102-d, and the AP 102-e may operate within a same mobility domain, such as a same IP sub-network. The AP 102-c, the AP 102-d, and the AP 102-e may each be in communication with the server 202-a and the cloud network 302. In such examples, the STA 104-b may associate with (such as connect to or access) the AP 102-c in accordance with the techniques described with reference to operations at 204 of FIG. 2. In response to the STA 104-b associating with the AP 102-c, the AP 102-c may establish a QoS context 304-a for a communication flow at the STA 104-b and begin to facilitate communication over the communication flow between the STA 104-b and the server 202-a. The AP 102-c may establish the QoS context 304-a according to the techniques described with reference to the operations at 206 and at 208 of FIG. 2.

In such examples, the AP 102-c may determine an intent of the STA 104-b to roam from a coverage area associated with the AP 102-c to a coverage area associated with the AP 102-d. The AP 102-c may determine the intent of the STA 104-b according to the techniques described with reference to the operations at 212 and at 214 of FIG. 2. In response to determining the intent of the STA 104-b to roam into the coverage area of the AP 102-d, the AP 102-c may transmit control signaling indicating the QoS context to the AP 102-d. In some examples, the AP 102-c may indicate the QoS context 304-a via a direct link, such as a direct backhaul Wi-Fi and/or ethernet link, to the AP 102-d. Alternatively, the AP 102-c may indicate the QoS context 304-a to the cloud network 302, in which the cloud network 302 may relay the QoS context 304-a to the AP 102-d. In this way, the AP 102-c may indicate the QoS context 304-a via direct communication or via the cloud network 302 to the AP 102-d.

In some other examples, the AP 102-c, the AP 102-f, and the AP 102-g may operate within a mesh network, in which the AP 102-c may be in communication with the server 202-a and the cloud network 302, while the AP 102-f and the AP 102-g may communicate with the server 202-a via the AP 102-c. In such examples, the AP 102-c may be referred to as a controller.

The STA 104-c may associate with (such as connect to or access) the AP 102-c in accordance with the techniques described with reference to operations at 204 of FIG. 2. In response to the STA 104-c associating with the AP 102-c, the AP 102-c may establish a QoS context 304-b for a communication flow at the STA 104-c and begin to facilitate communication over the communication flow between the STA 104-c and the server 202-a. For example, the AP 102-c may perform traffic classification to identify a classification of the communication flow associated with the STA 104-c and establish the QoS according to the classification. The AP 102-c may establish the QoS context 304-b according to the techniques described with reference to the operations at 206 and at 208 of FIG. 2.

In such examples, the AP 102-c may determine an intent of the STA 104-b to roam from a coverage area associated with the AP 102-c to a coverage area associated with the AP 102-f. The AP 102-c may determine the intent of the STA 104-b according to the techniques described with reference to the operations at 212 and at 214 of FIG. 2. As such, the AP 102-c may transmit control signaling indicating the QoS context 304-b to the AP 102-f. In such examples, the AP 102-c may transmit the control signaling to the AP 102-f via direct signaling using a backhaul ethernet connection and/or a backhaul Wi-Fi connection.

Because the AP 102-c and the AP 102-f operate in the mesh network, the AP 102-c also may indicate, via the control signaling, a hop count associated with the communication flow between the STA 104-c and the server 202-a, in which the hop count is equal to the quantity of communication links between the STA 104-c and the server 202-a. That is, in mesh networks, because the STA 104-c may be connected to an AP 102 that is several hops (communication links) away from the server 202-a, the AP 102 that is serving (connected to) the STA 104-a may adjust the QoS context 304-b to maintain the end-to-end QoS of the communication flow.

For example, prior to transmitting the control signaling indicating the QoS context 304-b and the hop count, the AP 102-c may determine the hop count associated with the communication flow, in which the hop count is from the perspective of the AP 102-c. For example, while the AP 102-c is serving the STA 104-c, the AP 102-c may determine the hop count to be equal to one, in which a communication link between the AP 102-c and the server 202-a may be a first hop. In such examples, the communication between the STA 104-a and the AP 102-c may not be considered a hop. Accordingly, the AP 102-c may transmit, via the control signaling, an indication of a single hop-hop count.

In response, the AP 102-f may determine a hop count of the communication flow between the STA 104-c and the server 202-a from the perspective of the AP 102-f according to the hop count received from the AP 102-c. For example, the AP 102-f may add an additional hop to the hop count of one received from the AP 102-c, such that the hop count from the perspective of the AP 102-f may be equal to two. For example, a communication link between the AP 102-f and the AP 102-c may be a first hop and a communication link between the AP 102-c and the server 202-a may be a second hop.

The AP 102-f may adjust the QoS context 304-b according to the updated hop count, such that the AP 10-2f may maintain an end-to-end QoS (an end-to-end SLA) for the communication flow. For example, because the QoS context 304-b was established for communication over a single hop communication link, the QoS context 304-b may not be able to be satisfied by the AP 102-f. As such, the AP 102-f may adjust various parameters of the QoS context 304-b, for example, by relaxing the QoS context 304-b. In response to adjusting the QoS context 304-b, the AP 102-f may apply QoS policies for the communication flow between the STA 104-c and the server 202-a according to the adjusted QoS context 304-b. In this way, the AP 102-f may maintain the end-to-end QoS for the communication flow.

In some examples, the STA 104-c may roam from the service area of the AP 102-c to a service area of the AP 102-g. In such examples, the AP 102-c may indicate the QoS context 304-b and the hop count to the AP 102-g, in which the AP 102-g may determine the hop count according to the hop count received from the AP 102-f, adjust the QoS context 304-b according to the determined hop count, and apply the QoS policies for the communication flow between the STA 104-c and the server 202-a according to the adjusted QoS context 304-b.

Similarly, if the STA 104-c roams from the service area of the AP 102-f to the service area of the AP 102-g, the AP 102-f may indicate the QoS context 304-b and the hop count to the AP 102-g, in which the AP 102-g may determine the hop count according to the hop count received from the AP 102-f, adjust the QoS context 304-b according to the determined hop count, and apply the QoS policies for the communication flow between the STA 104-c and the server 202-a according to the adjusted QoS context 304-b.

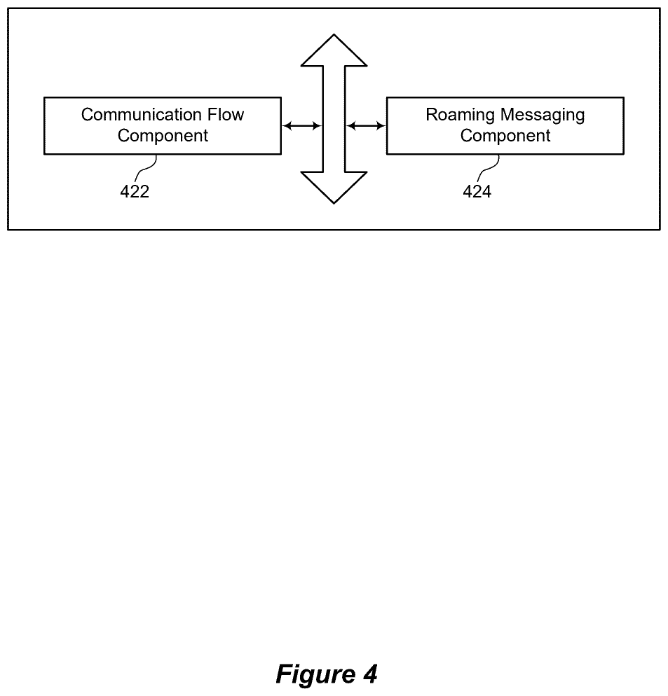

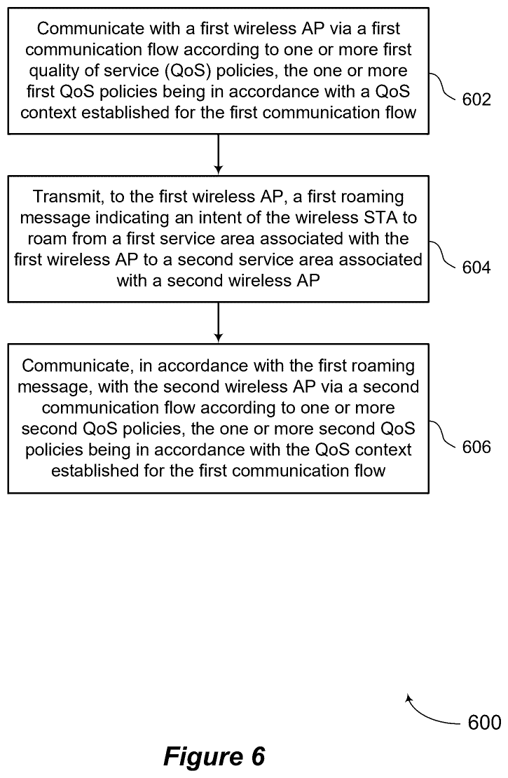

FIG. 4 shows a block diagram of an example wireless communication device that supports QoS context propagation in wireless communication systems. In some examples, the wireless communication device is configured to perform the process 600 described with reference to FIG. 6. The wireless communication device may include one or more chips, SoCs, chipsets, packages, components, or devices that individually or collectively constitute or include a processing system. The processing system may interface with other components of the wireless communication device and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device may transmit the information output from the chip. In such an example, the second interface may refer to an interface between the processing system of the chip and a reception component, such that the wireless communication device may receive information that is passed to the processing system. In some such examples, the first interface also may obtain information, such as from the transmission component, and the second interface also may output information, such as to the reception component.

The processing system of the wireless communication device includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device can be configurable or configured for use in a STA, such as the STA 104 described with reference to FIG. 1. In some other examples, the wireless communication device can be a STA that includes such a processing system and other components including multiple antennas. The wireless communication device is capable of transmitting and receiving wireless communication in the form of, for example, wireless packets. For example, the wireless communication device can be configurable or configured to transmit and receive packets in the form of physical layer PPDUs and MPDUs conforming to one or more of the IEEE 802.11 family of wireless communication protocol standards. In some other examples, the wireless communication device can be configurable or configured to transmit and receive signals and communication conforming to one or more 3GPP specifications including those for 5G NR or 6G. In some examples, the wireless communication device also includes or can be coupled with one or more application processors which may be further coupled with one or more other memories. In some examples, the wireless communication device further includes a user interface (UI) (such as a touchscreen or keypad) and a display, which may be integrated with the UI to form a touchscreen display that is coupled with the processing system. In some examples, the wireless communication device may further include one or more sensors such as, for example, one or more inertial sensors, accelerometers, temperature sensors, pressure sensors, or altitude sensors, that are coupled with the processing system.

The wireless communication device includes a communication flow component 422 and a roaming messaging component 424. Portions of one or more of the communication flow component 422 and the roaming messaging component 424 may be implemented at least in part in hardware or firmware. For example, one or more of the communication flow component 422 and the roaming messaging component 424 may be implemented at least in part by at least a processor or a modem. In some examples, portions of one or more of the communication flow component 422 and the roaming messaging component 424 may be implemented at least in part by a processor and software in the form of processor-executable code stored in memory.

The wireless communication device may support wireless communication in accordance with examples as disclosed herein. The communication flow component 422 is configurable or configured to communicate with a first wireless AP via a first communication flow according to one or more first QoS policies, the one or more first QoS policies being in accordance with a QoS context established for the first communication flow. The roaming messaging component 424 is configurable or configured to transmit, to the first wireless AP, a first roaming message indicating an intent of the wireless STA to roam from a first service area associated with the first wireless AP to a second service area associated with a second wireless AP. In some examples, the communication flow component 422 is configurable or configured to communicate, in accordance with the first roaming message, with the second wireless AP via a second communication flow according to one or more second QoS policies, the one or more second QoS policies being in accordance with the QoS context established for the first communication flow.

In some examples, the roaming messaging component 424 is configurable or configured to receive, from the first wireless AP, a second roaming message indicating an acknowledgement of the intent of the wireless STA to roam from the first service area associated with the first wireless AP to the second service area associated with the second wireless AP. In such examples, the communication of the second wireless AP via the second communication flow is in accordance with the second roaming message.

In some examples, the communication flow component 422 is configurable or configured to associate with the first wireless AP. In such examples, the communication via the first communication flow is in accordance with associating with the first wireless AP.

In some examples, the communication flow component 422 is configurable or configured to communicate, with the first wireless AP, one or more SCS messages to establish the QoS context for the first communication flow. In such examples, the communication via the first communication flow is in accordance with communicating the one or more SCS messages.

In some examples, the QoS context established for the first communication flow is in accordance with a classification of the first communication flow, and the classification of the first communication flow is based at least in part on an artificial intelligence model, a machine learning model, a packet inspection algorithm, or a combination thereof.

In some examples, the QoS context established for the first communication flow is in accordance with one or more SLA administration configurations.

In some examples, the first roaming message includes an identifier associated with the second wireless AP, and communicating with the second wireless AP over the second communication flow is in accordance with the first roaming message including the identifier associated with the second wireless AP.

In some examples, the QoS context includes one or more of one or more KPIs, one or more latency metrics, one or more throughput metrics, one or more delay bounds, one or more SCS parameters, or a combination thereof.

In some examples, the one or more first QoS policies include a first scheduling priority associated with the first communication flow, and the one or more second QoS policies include a second scheduling priority associated with the second communication flow.

In some examples, the first wireless AP and the second wireless AP are associated with a same IP sub-network.

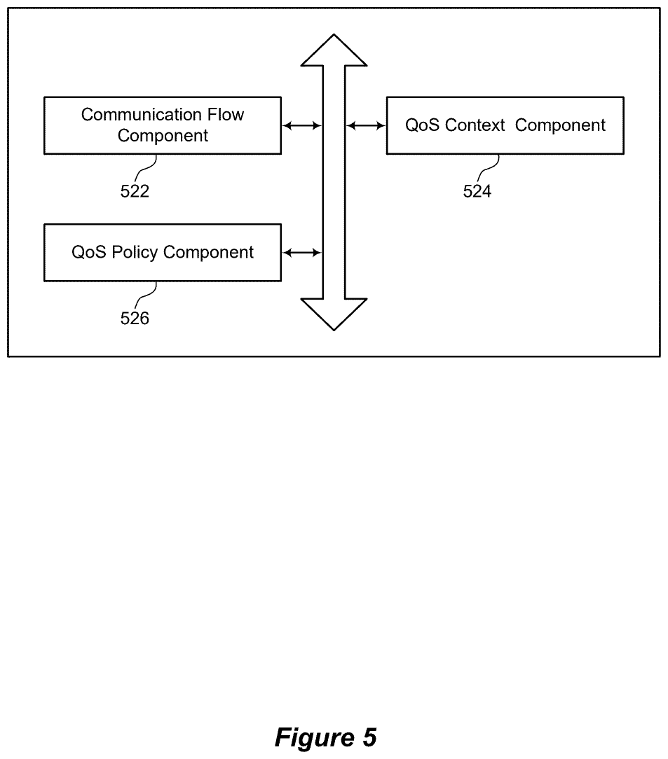

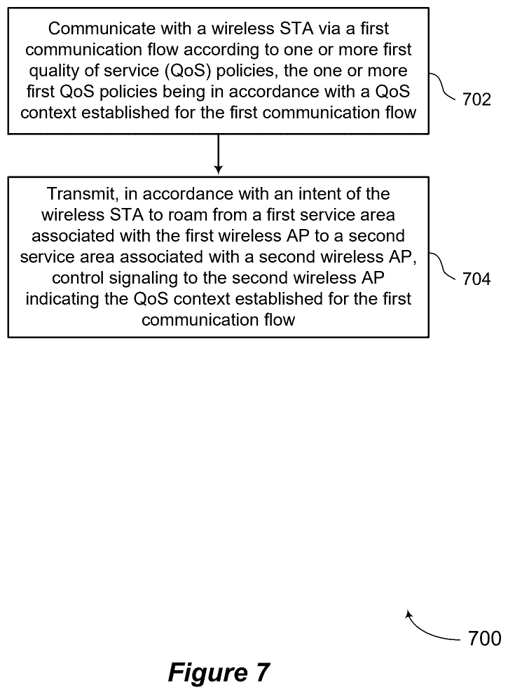

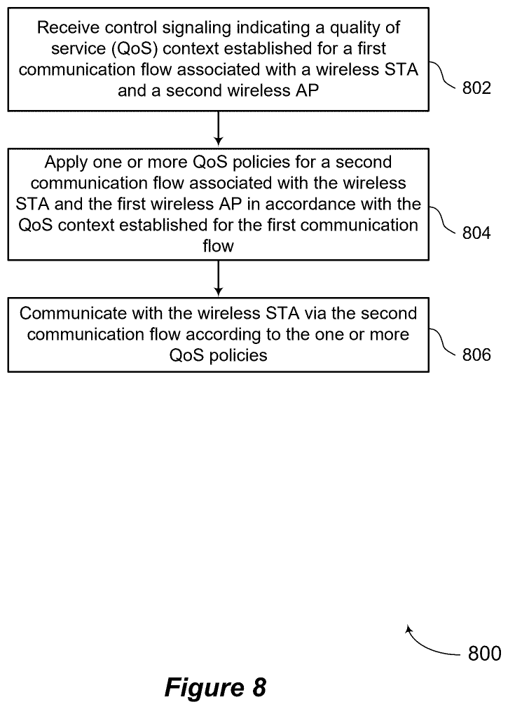

FIG. 5 shows a block diagram of an example wireless communication device that supports QoS context propagation in wireless communication systems. In some examples, the wireless communication device is configured to perform the process 700 and the process 800 described with reference to FIGS. 7 and 8, respectively. The wireless communication device may include one or more chips, SoCs, chipsets, packages, components, or devices that individually or collectively constitute or include a processing system. The processing system may interface with other components of the wireless communication device and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device may transmit the information output from the chip. In such an example, the second interface may refer to an interface between the processing system of the chip and a reception component, such that the wireless communication device may receive information that is passed to the processing system. In some such examples, the first interface also may obtain information, such as from the transmission component, and the second interface also may output information, such as to the reception component.

The processing system of the wireless communication device includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device can be configurable or configured for use in an AP, such as the AP 102 described with reference to FIG. 1. In some other examples, the wireless communication device can be an AP that includes such a processing system and other components including multiple antennas. The wireless communication device is capable of transmitting and receiving wireless communication in the form of, for example, wireless packets. For example, the wireless communication device can be configurable or configured to transmit and receive packets in the form of physical layer PPDUs and MPDUs conforming to one or more of the IEEE 802.11 family of wireless communication protocol standards. In some other examples, the wireless communication device can be configurable or configured to transmit and receive signals and communication conforming to one or more 3GPP specifications including those for 5G NR or 6G. In some examples, the wireless communication device also includes or can be coupled with one or more application processors which may be further coupled with one or more other memories. In some examples, the wireless communication device further includes at least one external network interface coupled with the processing system that enables communication with a core network or backhaul network that enables the wireless communication device to gain access to external networks including the Internet.

The wireless communication device includes a communication flow component 522, a QoS context component 524, and a QoS policy component 526. Portions of one or more of the communication flow component 522, the QoS context component 524, and the QoS policy component 526 may be implemented at least in part in hardware or firmware. For example, one or more of the communication flow component 522, the QoS context component 524, and the QoS policy component 526 may be implemented at least in part by at least a processor or a modem. In some examples, portions of one or more of the communication flow component 522, the QoS context component 524, and the QoS policy component 526 may be implemented at least in part by a processor and software in the form of processor-executable code stored in memory.

The wireless communication device may support wireless communication in accordance with examples as disclosed herein. The communication flow component 522 is configurable or configured to communicate with a wireless STA via a first communication flow according to one or more first QoS policies, the one or more first QoS policies being in accordance with a QoS context established for the first communication flow. The QoS context component 524 is configurable or configured to transmit, in accordance with an intent of the wireless STA to roam from a first service area associated with the first wireless AP to a second service area associated with a second wireless AP, control signaling to the second wireless AP indicating the QoS context established for the first communication flow.

In some examples, the QoS context component 524 is configurable or configured to communicate, with the wireless STA, one or more SCS messages to establish the QoS context for the first communication flow. In such examples, the communication via the first communication flow is in accordance with communicating the one or more SCS messages.

In some examples, the QoS context component 524 is configurable or configured to determine a classification associated with the first communication flow in accordance with one or more data packets communicated over the first communication flow. In some examples, the QoS context component 524 is configurable or configured to establish the QoS context for the first communication flow in accordance with the classification associated with the first communication flow.

In some examples, determining the classification associated with the communication flow is in accordance with one of a ML model, an AI model, or both.

In some examples, the QoS context component 524 is configurable or configured to establish the QoS context for the first communication flow in accordance with one or more SLA administration configurations.

In some examples, the communication flow component 522 is configurable or configured to determine the intent of the wireless STA to roam from the first service area associated with the first wireless AP to the second service area associated with the second wireless AP.

In some examples, determining the intent of the wireless STA is in accordance with receiving, from the wireless STA, a first roaming message indicating the intent of the wireless STA to roam from the first service area associated with the first wireless AP to the second service area associated with the second wireless AP. In some examples, transmitting the QoS context to the second wireless AP is in accordance with receiving the first roaming message.

In some examples, the communication flow component 522 is configurable or configured to transmit, to the wireless STA, a second roaming message indicating an acknowledgement of the intent of the wireless STA to roam from the first service area associated with the first wireless AP to the second service area associated with the second wireless AP.

In some examples, the first roaming message includes an identifier associated with the second wireless AP, transmitting the QoS context to the second wireless AP is in accordance with the first roaming message including the identifier associated with the second wireless AP, and one or more second QoS policies of a second communication flow associated with the wireless STA and the second wireless AP are in accordance with the QoS context established for the first communication flow.

In some examples, the communication flow component 522 is configurable or configured to transmit, to the wireless STA and in accordance with determining the intent of the wireless STA, a first roaming message indicating the intent for the wireless STA to roam from the first service area associated with the first wireless AP to the second service area associated with the second wireless AP. In such examples, the transmission of the QoS context to the second wireless AP is in accordance with transmitting the first roaming message.

In some examples, the communication flow component 522 is configurable or configured to receive, from the wireless STA, a second roaming message indicating an acknowledgement of the intent of the wireless STA to roam from the first service area associated with the first wireless AP to the second service area associated with the second wireless AP.

In some examples, determining the intent of the wireless STA to roam is in accordance with analyzing one or more signals communicated between the wireless STA and the first wireless AP, is in accordance with performing a load balancing procedure at the first wireless AP, is in accordance with determining a quantity of failures associated with satisfying service level agreements (SLAs) associated with the first communication flow, or a combination thereof.

In some examples, the control signaling indicating the QoS context is broadcasted to two or more APs. In some examples, the two or more APs are neighbor APs to the first wireless AP, the two or more APs including the second wireless AP.

In some examples, the control signaling indicating the QoS context is transmitted via a cloud network associated with the first wireless AP and the second wireless AP.

In some examples, transmitting the control signaling indicating the QoS context is via direct communication between the first wireless AP and the second wireless AP.

In some examples, the QoS context includes one or more of one or more KPIs, one or more latency metrics, one or more delay bounds, one or more throughput metrics, one or more SCS parameters, or a combination thereof.

In some examples, the one or more first QoS policies include a first scheduling priority associated with the first communication flow.

Additionally, or alternatively, the wireless communication device may support wireless communication in accordance with examples as disclosed herein. In some examples, the QoS context component 524 is configurable or configured to receive control signaling indicating a QoS context established for a first communication flow associated with a wireless STA and a second wireless AP. The QoS policy component 526 is configurable or configured to apply one or more QoS policies for a second communication flow associated with the wireless STA and the first wireless AP in accordance with the QoS context established for the first communication flow. In some examples, the communication flow component 522 is configurable or configured to communicate with the wireless STA via the second communication flow according to the one or more QoS policies.

In some examples, the control signaling further indicates a hop count associated with the second communication flow, the hop count being in accordance with a quantity of communication links between the wireless STA and a server.

In some examples, the QoS context component 524 is configurable or configured to adjust one or more parameters of the QoS context in accordance with the hop count. In such examples, the application of the one or more QoS policies for the second communication flow is in accordance with adjusting the one or more parameters of the QoS context.

In some examples, the adjustment to the one or more parameters of the QoS context maintains an end-to-end SLA associated with the second communication flow.

In some examples, the control signaling indicating the QoS context is received via a cloud network associated with the first wireless AP and the second wireless AP.

In some examples, receiving the control signaling indicating the QoS context is via direct communication between the first wireless AP and the second wireless AP.

In some examples, the QoS context includes one or more of one or more KPIs, one or more latency metrics, one or more delay bounds, one or more throughput metrics, one or more SCS parameters, or a combination thereof.

In some examples, the one or more QoS policies include a scheduling priority associated with the second communication flow.

In some examples, the control signaling is received in accordance with an intent of the wireless STA to roam from a first service area associated with the second wireless AP to a second service area associated with the first wireless AP.

FIG. 6 shows a flowchart illustrating an example process 600 performable by or at a wireless STA that supports QoS context propagation in wireless communication systems. The operations of the process 600 may be implemented by a wireless STA or its components. For example, the process 600 may be performed by a wireless communication device, such as the wireless communication device described with reference to FIG. 4, operating as or within a wireless STA. In some examples, the process 600 may be performed by a wireless STA, such as one of the STAs 104 described with reference to FIG. 1.

In some examples, in 602, the wireless STA may communicate with a first wireless AP via a first communication flow according to one or more first QoS policies, the one or more first QoS policies being in accordance with a QoS context established for the first communication flow. The operations of 602 may be performed in accordance with examples as disclosed herein. In some implementations, aspects of the operations of 602 may be performed by a communication flow component 422 as described with reference to FIG. 4.

In some examples, in 604, the wireless STA may transmit, to the first wireless AP, a first roaming message indicating an intent of the wireless STA to roam from a first service area associated with the first wireless AP to a second service area associated with a second wireless AP. The operations of 604 may be performed in accordance with examples as disclosed herein. In some implementations, aspects of the operations of 604 may be performed by a roaming messaging component 424 as described with reference to FIG. 4.

In some examples, in 606, the wireless STA may communicate, in accordance with the first roaming message, with the second wireless AP via a second communication flow according to one or more second QoS policies, the one or more second QoS policies being in accordance with the QoS context established for the first communication flow. The operations of 606 may be performed in accordance with examples as disclosed herein. In some implementations, aspects of the operations of 606 may be performed by a communication flow component 422 as described with reference to FIG. 4.

FIG. 7 shows a flowchart illustrating an example process 700 performable by or at a first wireless AP that supports QoS context propagation in wireless communication systems. The operations of the process 700 may be implemented by a first wireless AP or its components. For example, the process 700 may be performed by a wireless communication device, such as the wireless communication device described with reference to FIG. 5, operating as or within a wireless AP. In some examples, the process 700 may be performed by a wireless AP, such as one of the APs 102 described with reference to FIG. 1.

In some examples, in 702, the first wireless AP may communicate with a wireless STA via a first communication flow according to one or more first QoS policies, the one or more first QoS policies being in accordance with a QoS context established for the first communication flow. The operations of 702 may be performed in accordance with examples as disclosed herein. In some implementations, aspects of the operations of 702 may be performed by a communication flow component 522 as described with reference to FIG. 5.

In some examples, in 704, the first wireless AP may transmit, in accordance with an intent of the wireless STA to roam from a first service area associated with the first wireless AP to a second service area associated with a second wireless AP, control signaling to the second wireless AP indicating the QoS context established for the first communication flow. The operations of 704 may be performed in accordance with examples as disclosed herein. In some implementations, aspects of the operations of 704 may be performed by a QoS context component 524 as described with reference to FIG. 5.

FIG. 8 shows a flowchart illustrating an example process 800 performable by or at a first wireless AP that supports QoS context propagation in wireless communication systems. The operations of the process 800 may be implemented by a first wireless AP or its components. For example, the process 800 may be performed by a wireless communication device, such as the wireless communication device described with reference to FIG. 5, operating as or within a wireless AP. In some examples, the process 800 may be performed by a wireless AP, such as one of the APs 102 described with reference to FIG. 1.

In some examples, in 802, the first wireless AP may receive control signaling indicating a QoS context established for a first communication flow associated with a wireless STA and a second wireless AP. The operations of 802 may be performed in accordance with examples as disclosed herein. In some implementations, aspects of the operations of 802 may be performed by a QoS context component 524 as described with reference to FIG. 5.

In some examples, in 804, the first wireless AP may apply one or more QoS policies for a second communication flow associated with the wireless STA and the first wireless AP in accordance with the QoS context established for the first communication flow. The operations of 804 may be performed in accordance with examples as disclosed herein. In some implementations, aspects of the operations of 804 may be performed by a QoS policy component 526 as described with reference to FIG. 5.

In some examples, in 806, the first wireless AP may communicate with the wireless STA via the second communication flow according to the one or more QoS policies. The operations of 806 may be performed in accordance with examples as disclosed herein. In some implementations, aspects of the operations of 806 may be performed by a communication flow component 522 as described with reference to FIG. 5.

Implementation examples are described in the following numbered clauses:

Clause 1: A method for wireless communication by a wireless STA, including: communicating with a first wireless AP via a first communication flow according to one or more first QoS policies, the one or more first QoS policies being in accordance with a QoS context established for the first communication flow; transmitting, to the first wireless AP, a first roaming message indicating an intent of the wireless STA to roam from a first service area associated with the first wireless AP to a second service area associated with a second wireless AP; and communicating, in accordance with the first roaming message, with the second wireless AP via a second communication flow according to one or more second QoS policies, the one or more second QoS policies being in accordance with the QoS context established for the first communication flow.

Clause 2: The method of clause 1, further including receiving, from the first wireless AP, a second roaming message indicating an acknowledgement of the intent of the wireless STA to roam from the first service area associated with the first wireless AP to the second service area associated with the second wireless AP, where communicating with the second wireless AP via the second communication flow is in accordance with the second roaming message.

Clause 3: The method of any of clauses 1 through 2, further including associating with the first wireless AP, where communicating via the first communication flow is in accordance with associating with the first wireless AP.

Clause 4: The method of any of clauses 1 through 2, further including communicating, with the first wireless AP, one or more SCS messages to establish the QoS context for the first communication flow, where communicating via the first communication flow is in accordance with communicating the one or more SCS messages.

Clause 5: The method of any of clauses 1 through 2, where the QoS context established for the first communication flow is in accordance with a classification of the first communication flow, and the classification of the first communication flow is based at least in part on an artificial intelligence model, a machine learning model, a packet inspection algorithm, or a combination thereof.

Clause 6: The method of any of clauses 1 through 2, where the QoS context established for the first communication flow is in accordance with one or more SLA administration configurations.

Clause 7: The method of any of clauses 1 through 6, where the first roaming message includes an identifier associated with the second wireless AP, and communicating with the second wireless AP over the second communication flow is in accordance with the first roaming message including the identifier associated with the second wireless AP.

Clause 8: The method of any of clauses 1 through 7, where the QoS context includes one or more of one or more KPIs, one or more latency metrics, one or more delay bounds, one or more throughput metrics, one or more SCS parameters, or a combination thereof.

Clause 9: The method of any of clauses 1 through 8, where the one or more first QoS policies include a first scheduling priority associated with the first communication flow, and the one or more second QoS policies include a second scheduling priority associated with the second communication flow.

Clause 10: The method of any of clauses 1 through 9, where the first wireless AP and the second wireless AP are associated with a same IP sub-network.

Clause 11: A method for wireless communication at a first wireless AP, including: communicating with a wireless STA via a first communication flow according to one or more first QoS policies, the one or more first QoS policies being in accordance with a QoS context established for the first communication flow; and transmitting, in accordance with determining that the wireless STA is to roam from a first service area associated with the first wireless AP to a second service area associated with a second wireless AP, control signaling to the second wireless AP indicating the QoS context established for the first communication flow.

Clause 12: The method of clause 11, further including communicating, with the wireless STA, one or more SCS messages to establish the QoS context for the first communication flow, where communicating via the first communication flow is in accordance with communicating the one or more SCS messages.

Clause 13: The method of any of clauses 11 through 12, further including: determining a classification associated with the first communication flow in accordance with one or more data packets communicated over the first communication flow; and establishing the QoS context for the first communication flow in accordance with the classification associated with the first communication flow.

Clause 14: The method of clause 13, where determining the classification associated with the communication flow is in accordance with one of a machine learning model, an artificial intelligence model, or both.

Clause 15: The method of any of clauses 11 through 12, further including establishing the QoS context for the first communication flow in accordance with one or more SLA administration configurations.

Clause 16: The method of any of clauses 11 through 12, further including determining that the wireless STA is to roam from the first service area associated with the first wireless AP to the second service area associated with the second wireless AP.

Clause 17: The method of clause 16, where determining that the wireless STA is to roam is in accordance with receiving, from the wireless STA, a first roaming message indicating an intent of the wireless STA to roam from the first service area associated with the first wireless AP to the second service area associated with the second wireless AP, and transmitting the QoS context to the second wireless AP is in accordance with receiving the first roaming message.

Clause 18: The method of clause 17, further including transmitting, to the wireless STA, a second roaming message indicating an acknowledgement of the intent of the wireless STA to roam from the first service area associated with the first wireless AP to the second service area associated with the second wireless AP.

Clause 19: The method of any of clauses 17 through 18, where the first roaming message includes an identifier associated with the second wireless AP, transmitting the QoS context to the second wireless AP is in accordance with the first roaming message including the identifier associated with the second wireless AP, and one or more second QoS policies of a second communication flow associated with the wireless STA and the second wireless AP are in accordance with the QoS context established for the first communication flow.

Clause 20: The method of any of clause 16, further including transmitting, to the wireless STA and in accordance with determining that the wireless STA is to roam, a first roaming message indicating for the wireless STA to roam from the first service area associated with the first wireless AP to the second service area associated with the second wireless AP, where transmitting the QoS context to the second wireless AP is in accordance with transmitting the first roaming message.

Clause 21: The method of clause 20, further including receiving, from the wireless STA, a second roaming message indicating an acknowledgement that the wireless STA is to roam from the first service area associated with the first wireless AP to the second service area associated with the second wireless AP.

Clause 22: The method of any of clause 16, where determining that the wireless STA is to roam is in accordance with analyzing one or more signals communicated between the wireless STA and the first wireless AP, in accordance with performing a load balancing procedure at the first wireless AP, in accordance with determining a quantity of failures associated with satisfying SLAs associated with the first communication flow, or a combination thereof.

Clause 23: The method of any of clauses 11 through 22, where the control signaling indicating the QoS context is broadcasted to two or more APs, and the two or more APs are neighbor APs to the first wireless AP, the two or more APs including the second wireless AP.

Clause 24: The method of any of clauses 11 through 22, where the control signaling indicating the QoS context is transmitted via a cloud network associated with the first wireless AP and the second wireless AP.

Clause 25: The method of any of clauses 11 through 22, where transmitting the control signaling indicating the QoS context is via direct communication between the first wireless AP and the second wireless AP.

Clause 26: The method of any of clauses 11 through 25, where the QoS context includes one or more of one or more KPIs, one or more latency metrics, one or more delay bounds, one or more throughput metrics, one or more SCS parameters, or a combination thereof.

Clause 27: The method of any of clauses 11 through 26, where the one or more first QoS policies include a first scheduling priority associated with the first communication flow.

Clause 28: A method for wireless communication at a first wireless AP, including: receiving control signaling indicating a QoS context established for a first communication flow associated with a wireless STA and a second wireless AP; applying one or more QoS policies for a second communication flow associated with the wireless STA and the first wireless AP in accordance with the QoS context established for the first communication flow; and communicating with the wireless STA via the second communication flow according to the one or more QoS policies.

Clause 29: The method of clause 28, where the control signaling further indicates a hop count associated with the second communication flow, the hop count being in accordance with a quantity of communication links between the wireless STA and a server.

Clause 30: The method of clause 29, further including adjusting one or more parameters of the QoS context in accordance with the hop count, where applying the one or more QoS policies for the second communication flow is in accordance with adjusting the one or more parameters of the QoS context.

Clause 31: The method of clause 30, where adjusting the one or more parameters of the QoS context maintains an end-to-end SLA associated with the second communication flow.

Clause 32: The method of any of clauses 28 through 31, where the control signaling indicating the QoS context is received via a cloud network associated with the first wireless AP and the second wireless AP.

Clause 33: The method of any of clauses 28 through 32, where receiving the control signaling indicating the QoS context is via direct communication between the first wireless AP and the second wireless AP.

Clause 34: The method of any of clauses 28 through 33, where the QoS context includes one or more of one or more KPIs, one or more latency metrics, one or more delay bounds, one or more throughput metrics, one or more SCS parameters, or a combination thereof.

Clause 35: The method of any of clauses 28 through 34, where the one or more QoS policies include a scheduling priority associated with the second communication flow.

Clause 36: The method of any of clauses 28 through 35, where the control signaling is received in accordance with an intent of the wireless STA to roam from a first service area associated with the second wireless AP to a second service area associated with the first wireless AP.

Clause 37: A wireless STA for wireless communication, including one or more memories storing processor-executable code, and one or more processors coupled with the one or more memories and individually or collectively operable to execute the code to cause the wireless STA to perform a method of any of clauses 1 through 10.

Clause 38: A wireless STA for wireless communication, including at least one means for performing a method of any of clauses 1 through 10.

Clause 39: A non-transitory computer-readable medium storing code for wireless communication, the code including instructions executable by one or more processors to perform a method of any of clauses 1 through 10.

Clause 40: A first wireless AP for wireless communication, including one or more memories storing processor-executable code, and one or more processors coupled with the one or more memories and individually or collectively operable to execute the code to cause the first wireless AP to perform a method of any of clauses 11 through 27.

Clause 41: A first wireless AP for wireless communication, including at least one means for performing a method of any of clauses 11 through 27.

Clause 42: A non-transitory computer-readable medium storing code for

wireless communication, the code including instructions executable by one or more processors to perform a method of any of clauses 11 through 27.

Clause 43: A first wireless AP for wireless communication, including one or more memories storing processor-executable code, and one or more processors coupled with the one or more memories and individually or collectively operable to execute the code to cause the first wireless AP to perform a method of any of clauses 28 through 36.

Clause 44: A first wireless AP for wireless communication, including at least one means for performing a method of any of clauses 28 through 36.

Clause 45: A non-transitory computer-readable medium storing code for wireless communication, the code including instructions executable by one or more processors to perform a method of any of clauses 28 through 36.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless station (STA), comprising:
a processing system that includes processor circuitry and memory circuitry that stores code, the processing system configured to cause the wireless STA to:
communicate with a first wireless access point (AP) via a first communication flow according to one or more first quality of service (QoS) policies, the one or more first QoS policies being in accordance with a QoS context established for the first communication flow;
transmit, to the first wireless AP, a first roaming message indicating an intent of the wireless STA to roam from a first service area associated with the first wireless AP to a second service area associated with a second wireless AP; and
communicate, in accordance with the first roaming message, with the second wireless AP via a second communication flow according to one or more second QoS policies, the one or more second QoS policies being in accordance with the QoS context established for the first communication flow.

2. The wireless STA of claim 1, wherein the processing system is further configured to cause the wireless STA to receive, from the first wireless AP, a second roaming message indicating an acknowledgement of the intent of the wireless STA to roam from the first service area associated with the first wireless AP to the second service area associated with the second wireless AP, wherein communicating with the second wireless AP via the second communication flow is in accordance with the second roaming message.

3. The wireless STA of claim 1, wherein the processing system is further configured to cause the wireless STA to associate with the first wireless AP, wherein communicating via the first communication flow is in accordance with associating with the first wireless AP.

4. The wireless STA of claim 1, wherein the processing system is further configured to cause the wireless STA to communicate, with the first wireless AP, one or more stream classification service (SCS) messages to establish the QoS context for the first communication flow, wherein communicating via the first communication flow is in accordance with communicating the one or more SCS messages.

5. The wireless STA of claim 1, wherein the QoS context established for the first communication flow is in accordance with one or more service level agreement (SLA) administration configurations.

6. The wireless STA of claim 1, wherein the first roaming message comprises an identifier associated with the second wireless AP, and communicating with the second wireless AP over the second communication flow is in accordance with the first roaming message comprising the identifier associated with the second wireless AP.

7. The wireless STA of claim 1, wherein the QoS context comprises one or more of one or more key performance indicators (KPIs), one or more latency metrics, one or more delay bounds, one or more throughput metrics, one or more stream classification service (SCS) parameters, or a combination thereof.

8. The wireless STA of claim 1, wherein the one or more first QoS policies comprise a first scheduling priority associated with the first communication flow, and the one or more second QoS policies comprise a second scheduling priority associated with the second communication flow.

9. The wireless STA of claim 1, wherein the first wireless AP and the second wireless AP are associated with a same internet protocol (IP) sub-network.

10. A first wireless access point (AP), comprising:
a processing system that includes processor circuitry and memory circuitry that stores code, the processing system configured to cause the first wireless AP to:
communicate with a wireless station (STA) via a first communication flow according to one or more first quality of service (QoS) policies, the one or more first QoS policies being in accordance with a QoS context established for the first communication flow; and
transmit, in accordance with determining that the wireless STA is to roam from a first service area associated with the first wireless AP to a second service area associated with a second wireless AP, control signaling to the second wireless AP indicating the QoS context established for the first communication flow.

11. The first wireless AP of claim 10, wherein the processing system is further configured to cause the first wireless AP to:
determine a classification associated with the first communication flow in accordance with one or more data packets communicated over the first communication flow; and
establish the QoS context for the first communication flow in accordance with the classification associated with the first communication flow.

12. The first wireless AP of claim 11, wherein determining the classification associated with the communication flow is in accordance with one of a machine learning model, an artificial intelligence model, or both.

13. The first wireless AP of claim 10, wherein the processing system is further configured to cause the first wireless AP to determine that the wireless STA is to roam from the first service area associated with the first wireless AP to the second service area associated with the second wireless AP.

14. The first wireless AP of claim 13, wherein the processing system is further configured to cause the first wireless AP to transmit, to the wireless STA and in accordance with determining that the wireless STA is to roam, a first roaming message indicating for the wireless STA to roam from the first service area associated with the first wireless AP to the second service area associated with the second wireless AP, wherein transmitting the QoS context to the second wireless AP is in accordance with transmitting the first roaming message.

15. The first wireless AP of claim 14, wherein the processing system is further configured to cause the first wireless AP to receive, from the wireless STA, a second roaming message indicating an acknowledgement that the wireless STA is to roam from the first service area associated with the first wireless AP to the second service area associated with the second wireless AP.

16. The first wireless AP of claim 13, wherein determining that the wireless STA is to roam is in accordance with analyzing one or more signals communicated between the wireless STA and the first wireless AP, in accordance with performing a load balancing procedure at the first wireless AP, in accordance with determining a quantity of failures associated with satisfying service level agreements (SLAs) associated with the first communication flow, or a combination thereof.

17. The first wireless AP of claim 10, wherein the control signaling indicating the QoS context is broadcasted to two or more APs, and the two or more APs are neighbor APs to the first wireless AP, the two or more APs comprising the second wireless AP.

18. The first wireless AP of claim 10, wherein the control signaling indicating the QoS context is transmitted via a cloud network associated with the first wireless AP and the second wireless AP.

19. The first wireless AP of claim 10, wherein transmitting the control signaling indicating the QoS context is via direct communication between the first wireless AP and the second wireless AP.

20. The first wireless AP of claim 10, wherein the QoS context comprises one or more of one or more key performance indicators (KPIs), one or more latency metrics, one or more delay bounds, one or more throughput metrics, one or more stream classification service (SCS) parameters, or a combination thereof.

21. The first wireless AP of claim 10, wherein the one or more first QoS policies comprise a first scheduling priority associated with the first communication flow.

22. A first wireless access point (AP), comprising:
a processing system that includes processor circuitry and memory circuitry that stores code, the processing system configured to cause the first wireless AP to:
receive control signaling indicating a quality of service (QoS) context established for a first communication flow associated with a wireless station (STA) and a second wireless AP;
apply one or more QoS policies for a second communication flow associated with the wireless STA and the first wireless AP in accordance with the QoS context established for the first communication flow; and
communicate with the wireless STA via the second communication flow according to the one or more QoS policies.

23. The first wireless AP of claim 22, wherein the control signaling further indicates a hop count associated with the second communication flow, the hop count being in accordance with a quantity of communication links between the wireless STA and a server.

24. The first wireless AP of claim 23, wherein the processing system is further configured to cause the first wireless AP to adjust one or more parameters of the QoS context in accordance with the hop count, wherein applying the one or more QoS policies for the second communication flow is in accordance with adjusting the one or more parameters of the QoS context.

25. The first wireless AP of claim 24, wherein adjusting the one or more parameters of the QoS context maintains an end-to-end service level agreement (SLA) associated with the second communication flow.

26. The first wireless AP of claim 22, wherein the control signaling indicating the QoS context is received via a cloud network associated with the first wireless AP and the second wireless AP.

27. The first wireless AP of claim 22, wherein receiving the control signaling indicating the QoS context is via direct communication between the first wireless AP and the second wireless AP.

28. The first wireless AP of claim 22, wherein the QoS context comprises one or more of one or more key performance indicators (KPIs), one or more latency metrics, one or more delay bounds, one or more throughput metrics, one or more stream classification service (SCS) parameters, or a combination thereof.

29. The first wireless AP of claim 22, wherein the one or more QoS policies comprise a scheduling priority associated with the second communication flow.

30. A method for wireless communication by a wireless station (STA), comprising:
communicating with a first wireless access point (AP) via a first communication flow according to one or more first quality of service (QoS) policies, the one or more first QoS policies being in accordance with a QoS context established for the first communication flow;
transmitting, to the first wireless AP, a first roaming message indicating an intent of the wireless STA to roam from a first service area associated with the first wireless AP to a second service area associated with a second wireless AP; and
communicating, in accordance with the first roaming message, with the second wireless AP via a second communication flow according to one or more second QoS policies, the one or more second QoS policies being in accordance with the QoS context established for the first communication flow.
